(19) United States
(12) Patent Application Publication
(10) Pub. No.: US 2007/0233734 A1
(43) Pub. Date: Oct. 4, 2007

(54) ENHANCED USE OF MAP AND MAP METADATA

(75) Inventors: Magnus JENDBRO, Staffanstorp (SE); Brett A. PANTALONE, Pittsboro, NC (US)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/424,679

(22) Filed: Jun. 16, 2006

Related U.S. Application Data
(60) Provisional application No. 60/744,155, filed on Apr. 3, 2006.

(51) Int. Cl. G06F 7/00

(52) U.S. Cl. 707/104.1

(57) ABSTRACT

An electronic map together with metadata relating to at least one position on the map is provided for a user. A pointer to additional data related to the metadata may also be provided based on the reception of a selection of additional information according to a user made selection profile. In this way, additional data can be presented together with the metadata on the map and the density associated with information on the map may be increased.

### RELATED APPLICATION

This application claims priority under 35 U.S.C. § 119 based on U.S. Provisional Application Ser. No. 60/744,155, filed Apr. 3, 2006, the disclosure of which is incorporated herein by reference.

### TECHNICAL FIELD OF THE INVENTION

The invention relates to the provision of additional information for metadata associated with an electronic map. More particularly, the invention relates to a method and computer program products for providing additional data in relation to a map and map metadata, as well as to map providing devices and map providing servers.

### DESCRIPTION OF RELATED ART

Electronic maps are becoming increasingly popular in the field of electronic end user communication devices, such as lap top computers and cellular phones. In this regard, it is possible today to provide a map together with metadata where, for instance, certain points of interest such as stores and restaurants are provided.

It is furthermore known to provide friend finder functions in relation to a map, where it is possible to locate one's friends on a map. This is typically done through a user of a cellular phone sending the location of his phone and receiving the locations of other phones that exist in a group list. The different locations are then presented on a map.

U.S. Patent Publication No. 2003/0063128 describes the use of icons for messages received in a mobile terminal, where the messages may come from retail stores and restaurants. The size of the icons are then changed based on preferences by the user of the mobile terminal. However the icons are restricted to messages and there is furthermore no use of maps.

Portable communication devices, such as cellular phones, are furthermore getting smaller and smaller, and therefore, the displays are also getting smaller. There is, therefore, an increasing need to be able to condense the information as much as possible on these devices. At the same time, there is also a need to be able to present more information in relation to a map.

### SUMMARY OF THE INVENTION

Aspects of the invention are directed towards improving the information density of an electronic map, such as methods that enable the improvement of the information density of an electronic map.

According to a first aspect of the invention, this is achieved by a method of providing additional data in relation to a map and map metadata comprising the steps of: providing, for a user, an electronic map together with metadata relating to at least one position on the map, receiving a selection of additional information relating to the metadata associated with the position according to a user made selection profile, and providing at least a pointer to additional data related to the metadata associated with the position for presenting said additional data together with the metadata on the map.

A second aspect of the invention includes the steps of the first aspect, wherein the step of providing at least a pointer to additional data comprises providing a pointer for allowing the additional data to be fetched from a source related to the metadata.

A third aspect of the invention includes the steps of the first aspect, further comprising the step of fetching said additional data from a source related to the metadata, and the step of providing at least a pointer comprises providing the additional data for presenting with the metadata on the map.

A fourth aspect of the invention includes the steps of the first aspect, wherein the additional data is dynamic data.

A fifth aspect of the invention includes the steps of the first aspect, wherein the additional data provides status information regarding the metadata.

A sixth aspect of the invention includes the steps of the first aspect, wherein said selection profile is settable and further comprising the step of providing the settable selection profile regarding additional data to be set by the user and receiving said selection profile set by said user.

A seventh aspect of the invention includes the steps of the sixth aspect, further comprising the step of filtering a set of additional data according to the selection profile in order to provide additional data to be presented.

An eighth aspect of the invention includes the features of the seventh aspect, wherein the filtering includes filtering the metadata.

A ninth aspect of the invention includes the features of the first aspect, wherein metadata is presented as icons and additional information is presented through changing the appearance of an icon.

A tenth aspect of the invention includes the features of the first aspect, wherein the map metadata represents an object having a certain position on the map.

An eleventh aspect of the invention includes the features of the tenth aspect, wherein the map metadata represents different portable communication devices, the additional data represents the status of a first portable communication device and further comprising the step of setting up a communication session between the user and the first portable communication device in dependence of a selection by the user and in dependence of the status of the first portable communication device.

Other aspects of the invention provide a computer program product that enables the improvement of the information density of an electronic map.

According to a twelfth aspect of the invention, this is achieved by a computer program product for providing additional data in relation to a map and map metadata comprising: first computer program code for execution by a map providing device to, when said first computer program code is loaded in the map providing device, to cause the map providing device to: provide, for a user, an electronic map together with metadata relating to at least one position on the map, provide second computer program code for handling reception of a selection of additional information relating to the metadata associated with said position according to a user made selection profile, and provide at least a pointer to additional data related to the metadata associated with the position for presenting said additional data together with the metadata on the map.

A thirteenth aspect of the invention is directed towards computer program product for providing additional data in relation to a map and map metadata comprising computer program code executable by a map providing device, when the program code is loaded in the map providing device, to cause the map providing device to provide, for a user, an electronic map together with metadata relating to at least one position on the map, receive a selection of additional information relating to the metadata associated with said position according to a user made selection profile, and provide at least a pointer to additional data related to the metadata associated with the position for presenting said additional data together with the metadata on the map.

Still other aspects of the invention provide a map providing device that enables the improvement of the information density of an electronic map.

According to a fourteenth aspect of the invention, this is achieved by a map providing device being arranged to: provide, for a user, an electronic map together with metadata relating to at least one position on the map, receive a selection of additional information relating to the metadata associated with said position according to a user made selection profile and provide at least a pointer to additional data related to the metadata associated with the position for presenting said additional data together with the metadata on the map.

A fifteenth aspect of the invention includes the features of the fourteenth aspect, which when providing at least a pointer to additional data is arranged to provide a pointer for allowing the additional data to be fetched from a source related to the metadata.

A sixteenth aspect of the invention includes the features of the fourteenth aspect, being further arranged to fetch said additional data from a source related to the metadata and when providing at least a pointer is arranged to provide the additional data for presenting with the metadata on the map.

A seventeenth aspect of the invention includes the features of the fourteenth aspect, wherein the additional data is dynamic data.

An eighteenth aspect of the invention includes the features of the fourteenth aspect, wherein the additional data provides status information regarding the metadata.

A nineteenth aspect of the invention includes the features of the fourteenth aspect, where the selection profile is settable and the map providing device is being further arranged to provide the settable selection profile regarding additional data to be set by said user and receive a selection profile set by said user.

A twentieth aspect of the invention includes the features of the nineteenth aspect, being further arranged to filter a set of additional data according to the selection profile in order to provide additional data to be presented.

A twenty-first aspect of the invention includes the features of the twentieth aspect, wherein the filtering includes filtering the metadata.

A twenty-second aspect of the invention includes the features of the fourteenth aspect, wherein metadata is presented as icons and additional information is presented through changing the appearance of at least one icon.

A twenty-third aspect of the invention includes the features of the fourteenth aspect, wherein the map metadata represents an object having a certain position on the map.

A twenty-fourth aspect of the invention includes the features of the twenty-third aspect, wherein the map metadata represents different portable communication devices, the additional data represents the status of a first portable communication device and being further arranged to set up a communication session between the user and the first portable communication device in dependence of a selection by the user and in dependence of the status of the first portable communication device.

A twenty-fifth aspect of the invention includes the features of the fourteenth aspect, where a map providing server is configured to send the electronic map and the map metadata to an electronic end user device and receive selections of additional information.

A twenty-sixth aspect of the invention includes the features of the fourteenth aspect, where an electronic end user device is configured to receive selections of additional information from a user and present the map with metadata and additional data for the user.

A twenty-seventh aspect of the invention includes the features of the twenty-sixth aspect, wherein the electronic end user device is configured to receive the map and metadata from a map providing server.

A twenty-eighth aspect of the invention includes the features of the twenty-seventh aspect, being further arranged to receive at least said pointer to the additional data from the map providing server.

A twenty-ninth aspect of the invention includes the features of the twenty-sixth aspect, wherein the map providing device comprises a portable communication device.

A thirtieth aspect of the invention includes the features of the twenty-ninth aspect, wherein the map providing device comprises a cellular phone.

A thirty-first aspect of the invention is directed towards a map providing device comprising: means for providing, for a user, an electronic map together with metadata relating to at least one position on the map, means for receiving a selection of additional information relating to the metadata associated with said position according to a user made selection profile, and means for providing at least a pointer to additional data related to the metadata associated with the position for presenting said additional data together with the metadata on the map.

Still further aspects of the invention are directed towards providing a map providing server that enables the improvement of the information density of an electronic map.

According to a thirty-second aspect of the invention, this is achieved by a map providing server being arranged to: provide, for a user, an electronic map together with metadata relating to at least one position on the map, provide computer program code for handling reception of a selection of additional information relating to the metadata associated with the position according to a user made selection profile, and provide at least a pointer to additional data related to the metadata associated with the position for presenting said additional data together with the metadata on the map.

A thirty-third aspect of the invention is directed towards a map providing server comprising: means for providing, for a user, an electronic map together with metadata relating to at least one position on the map, means for providing computer program code for handling reception of a selection of additional information relating to the metadata associated with said position according to a user made selection profile, and means for providing at least a pointer to additional data related to the metadata associated with the position for presenting said additional data together with the metadata on the map.

Aspects of the invention provide, among other advantages, the following advantages. It improves the information density, which is important when small sized displays are used for presenting electronic maps. It also allows a user to select the type of information he is interested in. In this way, it allows a user to only see information that he is interested in. The data is thus customised to a user's preference. The data can furthermore be seen directly on a map.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The present invention will now be described in more detail in relation to the enclosed drawings, in which:

FIG. 1 illustrates an electronic end user communication device communicating with a map providing server via a network,

FIG. 2A illustrates the displaying of a map having metadata associated with a position on the map,

FIG. 2B illustrates a map where additional data related to the same metadata is displayed,

FIG. 3 schematically shows data transmitted from the map providing server to the electronic end user communication device according to a first embodiment of the present invention,

FIG. 4 schematically shows data transmitted between the map providing server and the electronic end user communication device according to a second embodiment of the present invention, and

FIG. 5 shows a CD ROM disc on which program code for executing a method consistent with the invention may be provided.

### DETAILED DESCRIPTION OF EMBODIMENTS

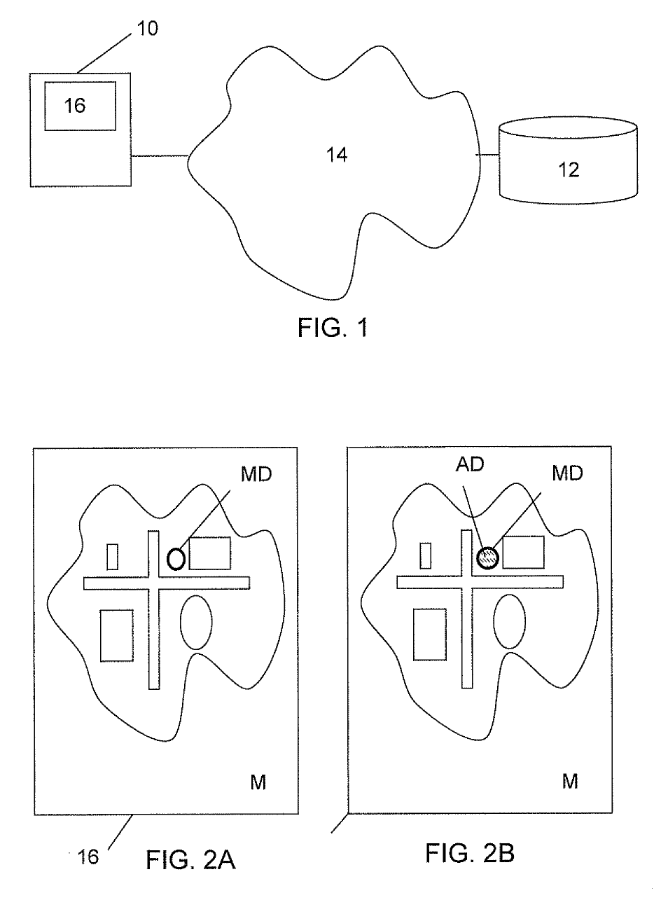

An electronic end user communication device 10 according to the present invention is schematically shown in FIG. 1. In FIG. 1, the electronic end user communication device 10 is connected to a map providing server 12 via a network 14. The electronic end user communication device 10 may be a personal computer (PC), but it may also be a portable communication device. It may for instance be a lap top computer, a palm top computer, an electronic organizer or a cellular phone. Electronic end user communication device 10, consistent with the invention, may have processing capabilities for receiving an electronic map and the ability to implement commands in relation to such a map for retrieving additional information. It may also be provided with the capability to set up communication sessions with other electronic end user communication devices. Because of the possibility to provide different types of electronic end user communication devices for use with the present invention, the network 14 may be a wireless network, for instance a wireless local area network (WLAN) or a wireless code division multiple access (WCDMA) network, or a fixed network, like the Internet. The electronic end user communication device 10 has a display 16, which in the case of a portable communication device is of a small size.

FIGS. 2A and 2B schematically show an electronic map M consistent with the invention shown on a display 16 of the electronic end user communication device 10. Such a map M may show various geographical features and as an example, the map is here a simplified urban map showing two crossing roads as well as a number of buildings. In the map there is furthermore provided metadata MD in the form of a symbol associated with a position of the map. For the sake of simplicity, there is only one such item of metadata shown. It should however be realized that normally several such items may be provided in relation to a map. The symbol is in this example an icon having an elliptical shape. In order to make clear that it is metadata MD that is not part of, but separate from, the map M, the ellipse is provided with a thicker line than the details on the map. The metadata MD can be provided for indicating the location of an establishment such as a restaurant, a store, indicate a shopping area, a park, public transportation or some other point of interest not ordinarily visible on a map. Such metadata typically indicates the position of a point of interest on a map, as well as a general classification of the type of said point of interest, but provides no other detailed information about said point of interest. Therefore, it is often desirable to supplement the map metadata with additional information, such as information from other sources, related to the map metadata.

With an electronic end user communication device 10 that is portable, the display area 16 is often limited. Therefore, it is not possible to show all information related to metadata of a map that it is desirable to show. Thus some type of limitation of the amount of information is often necessary. FIG. 2B shows some additional data AD related to the metadata MD that is displayed on the map M. This additional data AD is here, as an example, provided through changing the color of the symbol MD. It should here be realized that the additional data AD need not be provided through the changing of a color. It can, for instance, also be provided through changing the shape of the symbol or through varying the size, such as making it larger or smaller. The additional data AD may also be provided by changing the shading or thickness of the symbol or changing the appearance of the symbol in any other way that effectively changes its appearance. It is also possible to provide the additional data AD in the form of text. The additional data AD may here be an indication that a restaurant is open, the price class of a restaurant, type of menu, whether a park is friendly to children or pets, etc. It is also possible that the symbol MD is associated with a portable electronic communication device. In this case, the additional data can be a color indicating that the user of the device is busy, free, on the phone, etc. A different color may here be provided for indicating a different type of status. Since there is a lot of information that might be provided on a map and the display is of limited size, there may be a need for a filtering function for determining what additional information is to be shown.

Thus, the additional data can in many cases be dynamic and indicate the status of the metadata on the map.

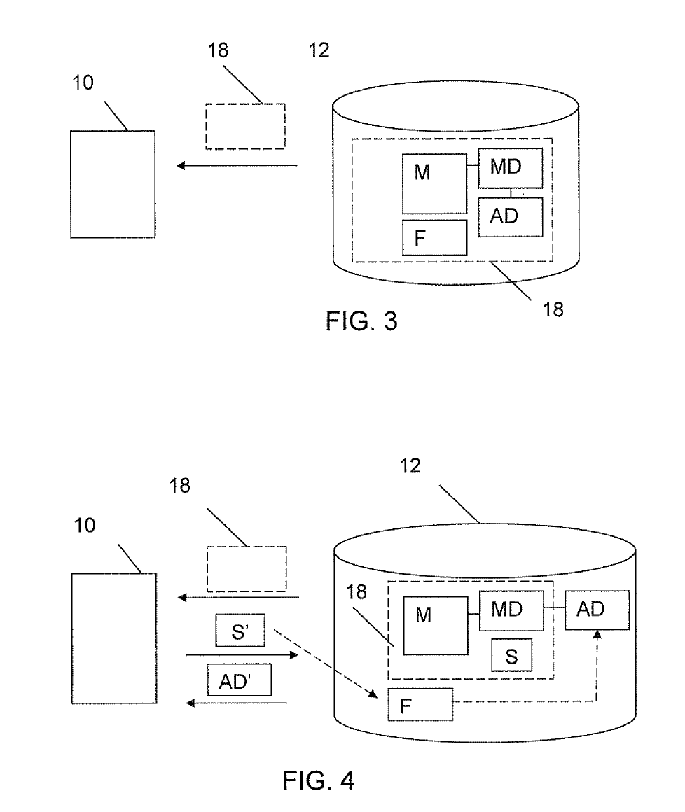

One way of implementing aspects of the invention according to a first embodiment will now be described with reference being made to FIG. 3, which schematically shows data sent from the server 12 to the electronic end user communication device 10. In FIG. 3, the map M, metadata MD and additional data AD together with a filter function F to be applied on at least the additional data are provided in the server 12. When a user of the electronic end user communication device 10 wants to obtain a map, he makes the device 10 send a request for a map to the server 12. As a response, the server 12 sends the map M, metadata MD and additional data AD together with the filter function F to the electronic end user communication device 10. All these elements axe shown as being provided within a dashed box 18. As can be seen, the whole content of the box 18 may be sent to the electronic end user communication device 10. That is, the data represented by the map M, metadata MD, additional data AD and filter function F may be sent to end user communication device 10. The electronic end user communication device 10 displays the map M and the metadata MD to the user of the electronic end user communication device 10 and in this way, the map M and metadata MD are provided to the user. The filter function F allows a selection profile to be set such that selected items of additional data AD associated with the metadata MD may be presented or used for presenting on the display. It is here possible that a pointer to a location where further additional data may be fetched is provided with the metadata MD instead of or in addition to additional data AD. This pointer may be a uniform resource locator (URL) link, an address or even a phone number used to retrieve information from a portable communication device. The filtering selection profile may be set using a check list or through use of a simple query language. Thus here the electronic end user communication device 10 provides a selection profile that is set by the user and used on the filter F for filtering additional data AD and selecting what additional data AD is to be presented and how. In this way, the user selects what parts of the additional data AD is to be provided on the MAP M, which may be a subset of all the additional data provided by the server 12 and/or the location of the link. If the additional data is to be used for changing a symbol, the additional data may be used to control the shape of the symbol used for metadata. The server 12 may furthermore send a part of a map in the above described manner and if the user of the electronic end user communication device 10 wants to see another part of the map, this device 10 then only receives a new part of the map, metadata and additional data associated with that part of the map and uses the previously received filter function F for selecting additional data to be displayed.

According to another embodiment shown in FIG. 4, the filter mechanism F and the additional data AD is initially kept in the server 12. Here the server 12 initially sends the map M with metadata MD to the electronic end user communication device 10. However at the same time, it sends a settable selection profile S along with the map M and metadata MD. The user of the electronic end user communication device 10 may then set the profile S according to his wishes, and returns the set profile S′ to the server 12, which set profile S′ is then applied on the filter function F by the server 12 for selecting additional data to be provided along with the metadata. If there is a pointer instead of or together with the additional data AD, the server then fetches additional data from the location of the link if the profile S′ indicates that this should be done. The filtered additional data AD′ is then sent to the electronic end user communication device 10 and presented for the user on the map M and/or converted to code for changing the shape of metadata MD.

In case the electronic end user communication device 10 has phone capability, the metadata may be concerned with a phone and the additional data indicates that the phone is free to take a call, the end user device 10 may allow a user to set up a call to the phone.

Described above were just two embodiments of the invention. It is also possible to also apply the filter function on the metadata, for instance to allow a user to select to show metadata within an area defined by a maximum distance from a certain point on the map. Only metadata and additional data associated within that area may be displayed on the map. It is also possible to set the selection profile first in the electronic end user communication device and then use that for requesting and receiving map, metadata and additional data from the server. It is furthermore possible that the electronic end user communication device has the settable profile in place from the beginning and does not receive it from the server. It is furthermore possible that the map, metadata and filter function be provided in an electronic end user communication device, i.e., not on a server, in which case no server is needed. Thus, both an electronic end user communication device and a map providing server may be a map providing device.

Aspects of the invention provide, among other advantages, the following advantages. For example, aspects of the invention improve the information density, which may be advantageous when small sized displays are used. It also allows a user to select the type of information he is interested in. In this way it allows a user to only see information that he is interested in. The data is thus customised to a user's preference. The data can furthermore be seen directly on a map.

The electronic end user communication device according to the invention is preferably provided in the form of one or more processors with corresponding memory containing program code for performing the actions set out above and for controlling the display. For communication purposes, it may be provided with a communication unit that may be a communication interface such as radio communication unit provided as a separate hardware module, for instance in the form of an application specific integrated circuit (ASIC).

The server may likewise be implemented as a processor with corresponding memory comprising program code for performing the selection service devices. It also includes suitable memory for storing map, map metadata and additional data, for instance in the form of one or more hard discs, and may be provided with a suitable communication module for interfacing the network.

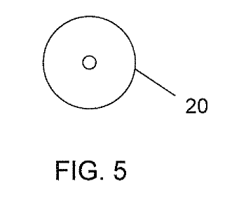

The program code mentioned above can also be provided on one or more computer program products such as a CD ROM disc 20 as depicted in FIG. 5, which will perform the functions of the invention when loaded into an electronic end user communication device having suitable processing capabilities or when loaded into the server. Naturally other types of products can be provided for this, like for instance a removable memory like a memory stick. The computer program product can also be provided as software, which is downloaded remotely from another server either outside or inside the network.

Although the invention has been described in connection with specific embodiments, it is not intended to be limited to the specific form set forth herein. Rather, the scope of the present invention is limited only by the accompanying claims and their equivalents.

What is claimed is:

1. A method of providing additional data in relation to a map and map metadata comprising:
providing, for a user, an electronic map together with metadata relating to at least one position on the map,
receiving a selection of additional information relating to the metadata associated with the position according to a user made selection profile, and
providing at least a pointer to additional data related to the metadata associated with the position for presenting said additional data together with the metadata on the map.

2. The method according to claim 1, wherein the step of providing at least a pointer to additional data comprises providing a pointer for allowing the additional data to be fetched from a source related to the metadata.

3. The method according to claim 1, further comprising:
fetching said additional data from a source related to the metadata, and
providing at least a pointer comprises providing the additional data for presenting with the metadata on the map.

4. The method according to claim 1, wherein the additional data is dynamic data.

5. The method according to claim 1, wherein the additional data provides status information regarding the metadata.

6. The method according to claim 1, wherein said selection profile is settable, the method further comprising providing said settable selection profile regarding additional data to be set by said user and receiving a user profile set by said user.

7. The method according to claim 6, further comprising filtering a set of additional data according to the selection profile in order to provide additional data to be presented.

8. The method according to claim 7, wherein the filtering includes filtering the metadata.

9. The method according to claim 1, wherein metadata is presented as icons and additional information is presented through changing the appearance of an icon.

10. The method according to claim 1, wherein the map metadata represents an object having a certain position on the map.

11. The method according to claim 10, wherein the map metadata represents different portable communication devices, the additional data represents the status of a first portable communication device, the method further comprising:
setting up a communication session between the user and the first portable communication device in dependence of a selection by the user and in dependence of the status of the first portable communication device.

12. A computer program product for providing additional data in relation to a map and map metadata comprising first computer program code for execution by a map providing device, when said first computer program code is loaded in the map providing device, to cause the map providing device to:
provide, for a user, an electronic map together with metadata relating to at least one position on the map,
provide second computer code for handling reception of a selection of additional information relating to the metadata associated with the position according to a user made selection profile, and
provide at least a pointer to additional data related to the metadata associated with the position for presenting said additional data together with the metadata on the map.

13. A computer program product for providing additional data in relation to a map and map metadata comprising computer program code executable by a map providing device, when said program code is loaded in the map providing device, to cause the map providing device to:
provide, for a user, an electronic map together with metadata relating to at least one position on the map,
receive a selection of additional information relating to the metadata associated with the position according to a user made selection profile, and
provide at least a pointer to additional data related to the metadata associated with the position for presenting said additional data together with the metadata on the map.

14. A map providing device being arranged to:
provide, for a user, an electronic map together with metadata relating to at least one position on the map,
receive a selection of additional information relating to the metadata associated with the position according to a user made selection profile, and
provide at least a pointer to additional data related to the metadata associated with the position for presenting said additional data together with the metadata on the map.

15. The map providing device according to claim 14, which when providing at least a pointer to additional data is arranged to provide a pointer for allowing the additional data to be fetched from a source related to the metadata.

16. The map providing device according to claim 14, being further arranged to fetch said additional data from a source related to the metadata and, when providing at least a pointer, is arranged to provide the additional data for presenting with the metadata on the map.

17. The map providing device according to claim 14, wherein the additional data is dynamic data.

18. The map providing device according to claim 14, wherein the additional data provides status information regarding the metadata.

19. The map providing device according to claim 14, where said selection profile is settable and the map providing device is being further arranged to provide said settable selection profile regarding additional data to be set by said user and receive a selection profile set by said user.

20. The map providing device according to claim 19, being further arranged to filter a set of additional data according to the selection profile in order to provide additional data to be presented.

21. The map providing device according to claim 20, wherein the filtering includes filtering the metadata.

22. The map providing device according to claim 14, wherein metadata is presented as icons and additional information is presented through changing the appearance of at least one icon.

23. The map providing device according to claim 14, wherein the map metadata represents an object having a certain position on the map.

24. The map providing device according to claim 23, wherein the map metadata represents different portable communication devices, the additional data represents the status of a first portable communication device and being further arranged to set up a communication session between the user and the first portable communication device in dependence of a selection by the user and in dependence of the status of the first portable communication device.

25. The map providing device according to claim 14, where a map providing server is configured to send the electronic map and the map metadata to an electronic end user device and receive selections of additional information.

26. The map providing device according to claim 14, where an electronic end user device is configured to receive selections of additional information from a user and present the map with metadata and additional data for the user.

27. The map providing device according to claim 26, wherein the electronic end user device is configured to receive the map and metadata from a map providing server.

28. The map providing device according to claim 27, being further arranged to receive at least said pointer to the additional data from the map providing server.

29. The map providing device according to claim 26, wherein the map providing device comprises a portable communication device.

30. The map providing device according to claim 29, wherein the map providing device comprises a cellular phone.

31. A map providing device comprising:
means for providing, for a user, an electronic map together with metadata relating to at least one position on the map,
means for receiving a selection of additional information relating to the metadata associated with said position according to a user made selection profile, and
means for providing at least a pointer to additional data related to the metadata associated with the position for presenting said additional data together with the metadata on the map.

32. A map providing server being arranged to:
provide, for a user, an electronic map together with metadata relating to at least one position on the map,
provide computer program code for handling reception of a selection of additional information relating to the metadata associated with the position according to a user made selection profile, and
provide at least a pointer to additional data related to the metadata associated with the position for presenting said additional data together with the metadata on the map.

33. A map providing server comprising:
means for providing, for a user, an electronic map together with metadata relating to at least one position on the map,
means for providing computer program code for handling reception of a selection of additional information relating to the metadata associated with the position according to a user made selection profile, and
means for providing at least a pointer to additional data related to the metadata associated with the position for presenting said additional data together with the metadata on the map.
